(19) United States
(12) Patent Application Publication
(10) Pub. No.: US 2013/0239221 A1
(43) Pub. Date: Sep. 12, 2013

(54) RIGHTS MANAGEMENT MODULE

(71) Applicant: Julie Conserva, Los Angeles, CA (US)

(72) Inventor: Julie Conserva, Los Angeles, CA (US)

(73) Assignee: CRACKLE, INC., Culver City, CA (US)

(21) Appl. No.: 13/418,132

(22) Filed: Mar. 12, 2012

(51) Int. Cl. G06F 21/24

(52) U.S. Cl. 726/26

(57) ABSTRACT

Assigning and managing rights to media content, including: receiving the media content along with a list of media rights definition from a content provider which describes what media availability rights apply to which media content; applying the defined media availability rights to the media content; and distributing the media content to a content consumer in accordance with the applied media availability rights. Keywords include media content and media availability rights.

### BACKGROUND

1. Field of the Invention

The present invention relates to assigning and managing media availability rights, and more specifically, to assigning and managing media availability rights for media content.

2. Background

Generally, content is provided to output devices based on arrangements made before the transmission from a source to the output devices. For example, content providers such as television stations, radio stations, Internet Service Providers, pager service companies, and other entities that provide a medium or network for transmitting content to an audience enter into agreements with the audience to deliver the content to an appropriate output device for a set fee.

### SUMMARY

The present invention provides for assigning and managing rights to media content including channels and assets.

In one implementation, a method of assigning and managing rights to media content including channels and assets is disclosed. The method includes: receiving the media content along with a list of media rights definition from a content provider which describes what media availability rights apply to which media content; applying the defined media availability rights to the media content; and distributing the media content to a content consumer in accordance with the applied media availability rights.

In another implementation, a rights management system is disclosed. The system includes: an interface unit configured to receive media content along with a list of media rights definition from a content provider which describes what media availability rights apply to which media content; and a rights assignment unit configured to assign media availability rights to the media content, and distribute the media content to a content consumer in accordance with the media availability rights.

In yet another implementation, a non-transitory storage medium storing a computer program to assign and manage rights to media content is disclosed. The computer program includes executable instructions that cause a computer to: receive the media content along with a list of media rights definition from a content provider which describes what media availability rights apply to which media content; apply the defined media availability rights to the media content; and distribute the media content to a content consumer in accordance with the applied media availability rights.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a functional block diagram of a rights management system in accordance with one implementation of the present invention.

FIG. 2 is a flowchart illustrating a method of assigning and managing rights to media content in accordance with one implementation of the present invention.

FIG. 3A illustrates a representation of a computer system and a user.

FIG. 3B is a functional block diagram illustrating the computer system hosting the rights manager.

### DETAILED DESCRIPTION

Certain implementations as disclosed herein provide for assigning and managing rights to media content including channels and assets. In one example, a channel is a television show and an asset is a single episode of the television show. In another example, a channel is a feature film, and an asset is an item of the feature film including a full length movie, trailer, or a list of various outtakes. After reading this description it will become apparent how to implement the invention in various implementations and applications. Although various implementations of the present invention will be described herein, it is understood that these implementations are presented by way of example only, and not limitation. As such, this detailed description of various implementations should not be construed to limit the scope or breadth of the present invention.

In one implementation, assigning and managing rights to media content includes applying media availability rights and reporting on the application such that the media content can be distributed only to approved platforms, territories, devices, etc., and be used for a pre-defined period of time. In one example, the media availability rights are applied to a single asset such as one episode of a television show. In an alternative, the media availability rights are applied to all assets of a single channel such as all episodes of a television show. In yet another alternative, the media availability rights are applied in bulk such as applying same media availability rights to all channels and assets coming from one content provider.

In another implementation, assigning and managing rights to media content includes a rights management unit configured to allow media availability rights to be applied to channels and assets so that they can be distributed only to approved platforms, territories, devices, etc., and be used for a pre-defined period of time. In this implementation, the rights management unit includes a definition module, an assignment module, and a reporting module. The definition module receives and/or defines what media rights apply to which media content. The assignment module assigns the media rights defined by the definition module to the media content including channels and assets. In one implementation, the assignment module assigns the media availability rights to a single channel (e.g., a television show or feature film) and/or asset (e.g., episode 1 of the television show or trailer 1 of the feature film). In another implementation, the assignment module assigns the media availability rights to multiple channels and/or assets. The assignment module can also transmit the media content along with its corresponding media rights to a content distributor. The reporting module reports on rights assigned at both the channel and the asset level. The reporting module also includes the ability to search, view, and export a report of rights in accordance with the criteria selected by a user.

To ensure distribution of the media content only to approved platforms, territories, devices, etc., and use only for the pre-defined period of time defined in the media availability rights, parameters of the media availability rights can be configured to trigger filter(s) for each parameter to inhibit the consumption of the media content in accordance with the definition of the parameters. For example, a territory parameter of the media availability rights that defines designated area(s) within which the media content can be consumed may trigger a geo-filter that inhibits the consumption of the media content outside the designated area(s).

The distribution of the media content along with its corresponding media availability rights involves selecting partners, platforms, territories, status, and duration. For example, a partner is an entity distributing the media content in accordance with its corresponding media availability rights. Platform is a designation of a device, such as a smart phone, game console, or web site, which will consume the media content. Territory defines the physical area where the media content is allowed to be consumed. Accordingly, the territory parameter of the media availability rights may trigger a geo-filter that inhibits the consumption of the media content outside a designated territory. Status indicates whether the content will be live or schedule. Duration defines the period when the media content is allowed to be consumed. The media availability rights may also include other parameters such as rights identifier, media identifier, channel/asset indicator, season, etc.

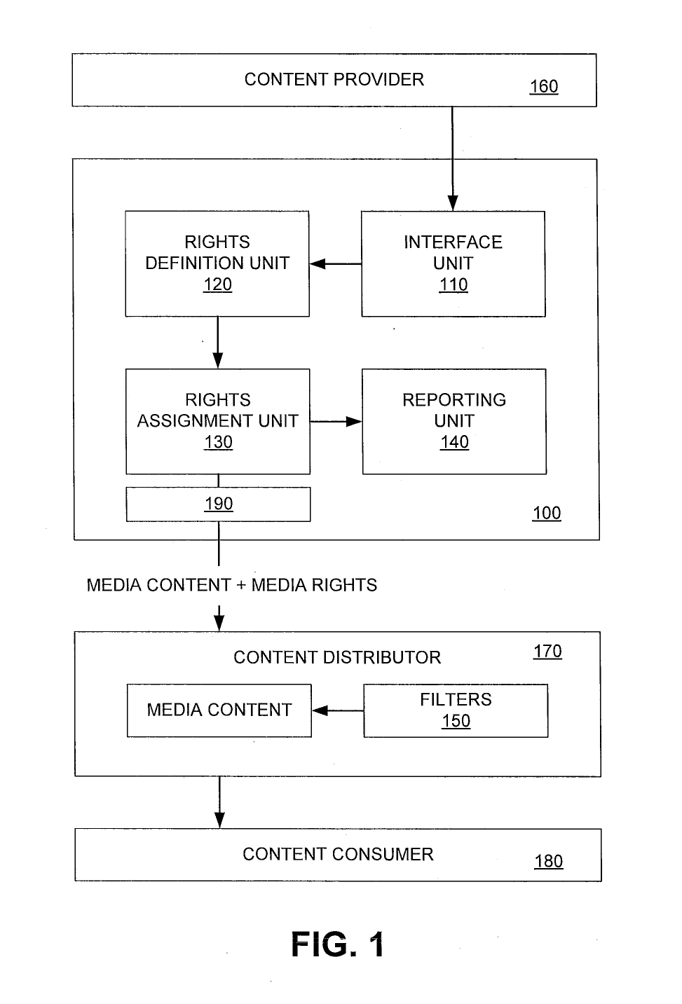

FIG. 1 is a functional block diagram of a rights management system 100 in accordance with one implementation of the present invention. The rights management system 100 is configured to assign and manage rights such that media availability rights can be applied to channels and assets, and distributed to approved platforms, territories, devices, etc., and be used for a pre-defined period of time. The rights management system 100 includes an interface unit 110, a rights definition unit 120, a rights assignment unit 130, and a reporting unit 140. In the illustrated implementation of FIG. 1, the media content and the corresponding media availability rights are transmitted to a content consumer device 180 via a content distributor 170. In an alternative, the right management system 100 can perform the functions of the content distributor 170.

The interface unit 110 receives media content along with a list of what media rights apply to which media content from a content provider 160. The definition unit 120 receives the list from the interface unit 110 and defines the media rights in formats applicable for the rights assignment unit 130. The rights assignment unit 130 assigns the media rights defined by the definition unit 120 to the media content including channels and assets. In one implementation, the rights assignment unit 130 assigns the media availability rights to a single channel (e.g., a television show or feature film) and/or asset (e.g., episode 1 of the television show or trailer 1 of the feature film). In another implementation, the rights assignment unit 130 assigns the media availability rights to multiple channels and/or assets. In the illustrated implementation, the rights assignment unit 130 also transmits the media content along with its corresponding media availability rights to a content distributor 170. In an alternative, the media content along with its corresponding media availability rights are transmitted to the content distributor 170 by a distribution unit 190. The reporting unit 140 reports on rights assigned at both the channel and the asset level. The reporting unit 140 also includes the ability to search, view, and export a report of rights in accordance with the criteria selected by a user. For example, the rights can be search by date window such as indicating that the media content can be used from Mar. 1, 2012 to Jul. 31, 2012. A filter can be set to show the report by asset type such that only the television shows with the date window as shown above are displayed on the report.

In one implementation, the media availability rights received with the media content from the rights management system 100 trigger various filters 150 within the content distributor 170 so that the media content can be distributed only to approved platforms, territories, devices, etc., and be used for a pre-defined period of time. For example, a territory parameter of the media availability rights can trigger a geo-filter that inhibits the consumption of the media content outside a designated territory. In another implementation, the filters 150 are located within the rights management system 100 or within the content consumer device 180. The filters 150 can also be configured as stand-alone units that control the availability of the media content in terms of the platforms, territories, devices, etc.

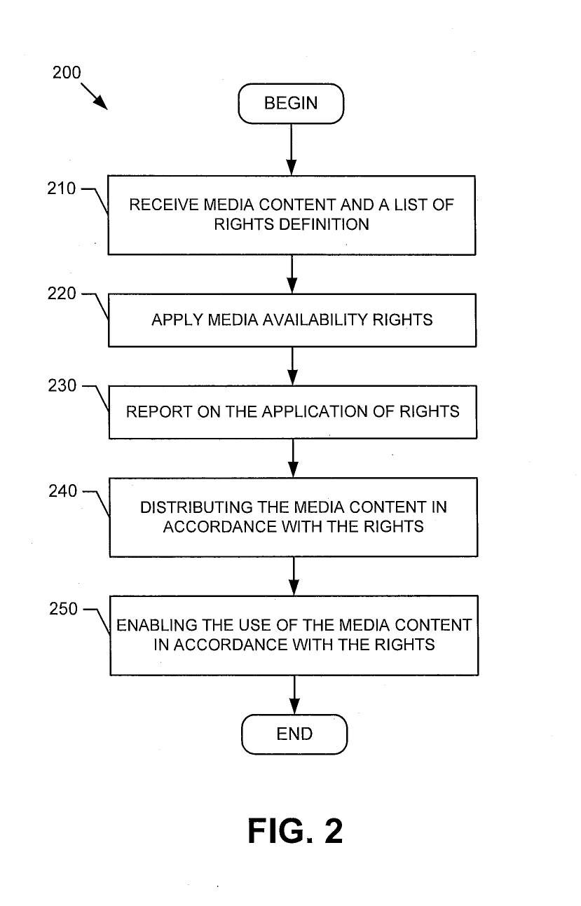

FIG. 2 is a flowchart 200 illustrating a method of assigning and managing rights to media content in accordance with one implementation of the present invention. The method includes receiving media content along with a list of media rights definition from a content provider, at box 210, which describes what media availability rights apply to which media content. The defined media availability rights are applied, at box 220, and the application of the rights is reported, at box 230. The method also includes distributing the media content, at box 240, only to approved platforms, territories, devices, etc., and enabling the use of the media content, at box 250, for a pre-defined period of time defined by the media availability rights. In one implementation, the media availability rights trigger various filters so that the media content can be distributed only to approved platforms, territories, devices, etc., and be used for a pre-defined period of time. For example, a territory parameter of the media availability rights can trigger a geo-filter that inhibits the consumption of the media content outside a designated territory.

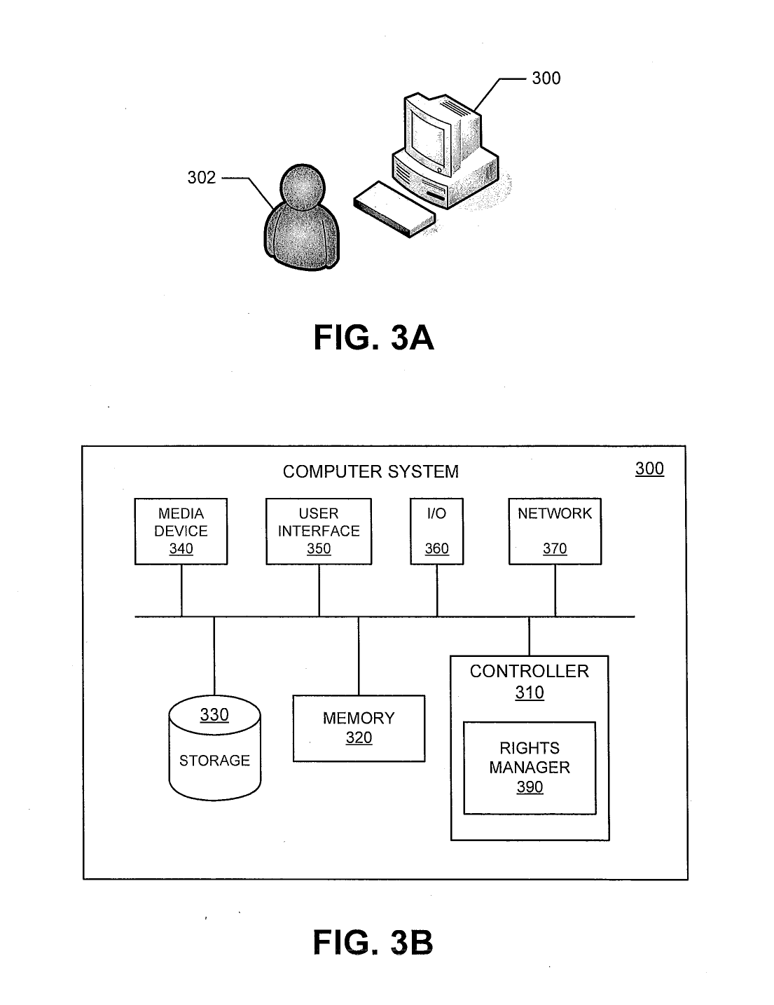

FIG. 3A illustrates a representation of a computer system 300 and a user 302. The user 302 uses the computer system 300 to assign and manage rights to media content. The computer system 300 stores and executes a rights manager 390.

FIG. 3B is a functional block diagram illustrating the computer system 300 hosting the rights manager 390. The controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the rights manager 390 as a software system. Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Non-transitory storage 330 stores data for use by other components of the computer system 300, such as for storing data used by the rights manager 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user 302 and presenting information to the user 302. In one implementation, the user interface 350 includes a keyboard, a mouse, audio speakers, and a display. The controller 310 uses input from the user 302 to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 302.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Accordingly, additional implementations and variations are also within s the scope of the invention. For example, although the specification focuses on the application of availability rights for media content, the rights can be applied to other non-media content including text files, game items, etc. Further, it is to be understood that the description and drawings presented herein are representative of the subject matter which is broadly contemplated by the present invention. It is further understood that the scope of the present invention fully encompasses other implementations that may become obvious to those skilled in the art and that the scope of the present invention is accordingly limited by nothing other than the appended claims.

Below is a functional specification of one implementation of the rights management system 100 illustrated in FIG. 1.

1. A method of assigning and managing rights to media content stored on a non-transitory storage medium using a processor, the method comprising:
receiving at the processor the media content along with a list of media rights definition from a content provider which describes what media availability rights apply to which media content,
wherein the media content comprises a plurality of channels and a plurality of assets, wherein a channel includes one of a television show and a feature film, and an asset includes one of an episode of the television show and an item of the feature film;
applying the defined media availability rights to the media content by the processor using the list of media rights definition; and
distributing the media content stored on a non-transitory storage medium to a content consumer in accordance with the applied media availability rights.

2. The method of claim 1, further comprising
reporting the application of the media availability rights.

3. The method of claim 1, wherein distributing the media content to a content consumer in accordance with the applied media availability rights comprises
distributing the media content to approved platforms, territories, and devices.

4. The method of claim 3, wherein distributing the media content to approved platforms, territories, and devices comprises
triggering various filters to distribute the media content only to approved platforms, territories, and devices.

5. The method of claim 1, wherein distributing the media content to a content consumer in accordance with the applied media availability rights comprises
distributing the media content by enabling the use of the media content for a pre-defined period of time defined by the media availability rights.

6. The method of claim 5, wherein distributing the media content to a content consumer in accordance with the applied media availability rights comprises
triggering various filters to distribute the media content by enabling use of the media content for a pre-defined period of time defined in the media availability rights.

7. The method of claim 6, wherein a filter of the various filters comprises a geo-filter that inhibits consumption of the media content outside a designated territory.

8. The system of claim 1, wherein an item of the feature film comprises at least one of a full length movie, a trailer, and a list of outtakes.

9. The method of claim 1, wherein applying the defined media availability rights to the media content comprises
assigning the media availability rights to one of a single channel of the plurality of channels and a single asset of the plurality of assets.

10. The method of claim 1, wherein applying the defined media availability rights to the media content comprises
assigning the media availability rights to at least one of the plurality of channels and the plurality of assets.

11. A rights management system managed by a processor, comprising:
an interface unit configured to receive media content stored on a non-transitory storage medium along with a list of media rights definition from a content provider which describes what media availability rights apply to which media content,
wherein the media content comprises a plurality of channels and a plurality of assets, wherein a channel includes one of a television show and a feature film, and an asset includes one of an episode of the television show and an item of the feature film; and
a rights assignment unit configured to interface with the processor to assign media availability rights to the media content using the list of media rights definition, and to distribute the media content stored on a non-transitory storage medium to a content consumer in accordance with the media availability rights.

12. The system of claim 11, wherein an item of the feature film comprises at least one of a full length movie, a trailer, and a list of outtakes.

13. The system of claim 12, further comprising
a reporting unit configured to report on rights assigned at both levels of channels and assets.

14. The system of claim 13, wherein the reporting unit is also configured to search, view, and export a report of rights in accordance with criteria selected by a user.

15. The system of claim 11, further comprising
a distribution unit configured to distribute the media content to a content consumer in accordance with the media availability rights.

16. The system of claim 15, further comprising
a plurality of filters triggered by the distribution unit to distribute the media content only to approved platforms, territories, and devices.

17. The system of claim 16, wherein the plurality of filters includes
a geo-filter that inhibits consumption of the media content outside a designated territory.

18. The system of claim 15, further comprising
a plurality of filters triggered by the distribution unit to distribute the media content by enabling the use of the media content for a pre-defined period of time defined by the media availability rights.

19. A non-transitory storage medium storing a computer program to assign and manage rights to media content, the computer program comprising executable instructions that cause a computer to:
receive the media content along with a list of media rights definition from a content provider which describes what media availability rights apply to which media content,
wherein the media content comprises a plurality of channels and a plurality of assets, wherein a channel includes one of a television show and a feature film, and an asset includes one of an episode of the television show and an item of the feature film;
apply the defined media availability rights to the media content using the list of media rights definition; and
distribute the media content to a content consumer in accordance with the applied media availability rights.

20. The non-transitory storage medium of claim 19, wherein executable instructions that cause a computer to distribute the media content to a content consumer in accordance with the applied media availability rights comprise executable instructions that cause a computer to
distribute the media content to approved platforms, territories, and devices.
